(19) United States
(12) Patent Application Publication
(10) Pub. No.: US 2006/0013315 A1
(43) Pub. Date: Jan. 19, 2006

(54) Filtering method, apparatus, and medium used in audio-video codec

(75) Inventor: Byung-cheol Song, Suwon-si (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRONICS CO., LTD., Suwon-si (KR)

(21) Appl. No.: 11/178,409

(22) Filed: Jul. 12, 2005

(30) Foreign Application Priority Data
Jul. 19, 2004 (KR) 10-2004-0055893

(51) Int. Cl. H04N 11/04; H04B 1/66; H04N 7/12; H04N 11/02

(52) U.S. Cl. 375/240.24; 375/240.29

(57) ABSTRACT

A filtering method, apparatus, and medium used in an audio-video codec are provided. The filtering method may include determining a predetermined macroblock as a filtering region; expanding the filtering region to further include a portion of a macroblock adjacent to the predetermined macroblock near a boundary between the predetermined macroblock and the macroblock adjacent to the predetermined macroblock; and performing a deblocking filtering operation on the expanded filtering region in a causal manner according to the passage of time. The filtering method, apparatus, and medium can be easily realized using a non-causal loop filter and buffers. The filtering method, apparatus, and medium can efficiently filter blocking artefacts without increasing a required memory bandwidth and causing frame delays.

### CROSS-REFERENCE TO RELATED APPLICATIONS

This application claims the benefit of Korean Patent Application No. 10-2004-0055893, filed on Jul. 19, 2004, in the Korean Intellectual Property Office, the disclosure of which is incorporated herein in its entirety by reference.

### BACKGROUND OF THE INVENTION

1. Field of the Invention

The present invention relates to a coder-and-decoder (codec), and more particularly, to a filtering method, apparatus, and medium used in an audio-video codec.

2. Description of the Related Art

Recently, Microsoft® Corporation submitted a draft of a moving picture compression standard dubbed “VC-1” (previously referred to as ‘VC9’) to the Society of Motion Picture and Television Engineers (SMPTE), an international standardization body. Currently, the examination of VC-1 is underway, and many experts expect VC-1 to be adopted as an international standard sooner or later.

VC-1 is also expected to become a leading moving picture compression standard in the near future, like Motion Picture Experts Group (MPEG)-2, MPEG-4, and H.264, which have already been adopted as moving picture compression standards and have been widely applied to various fields. VC-1 is about 60% less complicated than H.264 and achieves almost 80% of the compression efficiency of H.264, which is considered as one of the most efficient moving picture compression standards in terms of compression efficiency. In addition, VC-1 is also known to provide a higher picture quality than MPEG-2 or MPEG-4.

According to the existing moving picture compression standards briefly mentioned above, a digital image is encoded or decoded in units of blocks. Therefore, when decoding and then reproducing the digital image, boundaries between every pair of vertically or horizontally adjacent blocks of the digital image may be mistakenly rendered as if there were real boundaries. These pseudo boundaries are called blocking artifacts, and this phenomenon is called a blocking phenomenon. In order to prevent a blocking phenomenon, a loop filter, which is a filter included in a codec to deblock a digital image processed by the codec, is needed.

A VC-1 decoding method will be described in the following in greater detail.

FIG. 1 is a block diagram of a VC-1 decoder 110. Referring to FIG. 1, the VC-1 decoder 110 includes a bitstream parsing unit 115; a decoding part for I picture 120 including an inverse variable length coding (VLC) unit 122, an inverse quantization unit 124, and an inverse transformation unit; a decoding part for P & B pictures 130 including an inverse variable length coding (VLC) unit 132 and a prediction unit 134; a motion compensation unit 140; a combiner or an adder 145; an overlap smoothing and loop filtering unit 150; an intensity compensation and range scaling unit 160; a memory (e.g., buffer) 170; a decoded frame 180; and a post-decoding part 190 including a post filter 192, color transformation unit 194, and size adjustment unit 196. The present invention, which will be described later in this disclosure, relates to the overlap smoothing and loop filtering unit.

Supposing that OVERLAP and LOOPFILTER, which are sequence parameters, are set to 1, a picture which has been restored by passing it through the inverse VLC unit, the inverse quantization unit, and the inverse transformation unit, may be overlap-smoothed and then loop-filtered under several conditions. Before being used as a reference frame for motion compensation, the picture should be loop-filtered. In order to use the picture as a reference frame later for motion compensation, the VC-1 decoder 110 should perform a loop filtering operation on the picture in full compliance with VC-1. In general, since one picture is comprised of several slices, an overlap smoothing operation and a loop filtering operation should be performed in units of the slices.

A loop filtering operation will be described in the following in further detail.

A loop filtering operation is performed in order to prevent or minimize a blocking phenomenon that may occur near boundaries between pairs of vertically or horizontally adjacent 8×8 blocks of a picture during a quantization operation. Since an I picture is transformed into a group of 8×8 blocks, it should be vertically and horizontally loop-filtered in units of a multiple of 8 pixels. Therefore, the I picture may be vertically and horizontally loop-filtered in units of 8 pixels, 16 pixels, or 24 pixels.

A P picture, however, can be transformed into a group of 8×8 blocks, 8×4 subblocks, and/or 4×8 subblocks. Thus, the P picture is vertically and horizontally loop-filtered in units of a multiple of 4 pixels. Therefore, the P picture may be vertically and horizontally loop-filtered in units of 4 pixels, 8 pixels, or 12 pixels.

The loop filtering operation will now be described in further detail.

1) Loop Filtering of I Picture

A loop filtering operation (i.e., a de-blocking filtering operation) is performed on a boundary between every pair of vertically or horizontally adjacent blocks of an I picture in order to prevent a de-blocking phenomenon. FIG. 2 is a diagram illustrating the loop filtering of an I picture. Specifically, FIG. 2(a) illustrates the horizontal loop filtering of an upper left portion of an I picture having YCbCr, and FIG. 2(b) illustrates the vertical loop filtering of the upper left portion of the I picture. Referring to FIGS. 2(a) and 2(b), crosses (+) represent pixels, and encircled crosses (⊕) represent loop-filtered pixels. A first row of pixels from the top of the I picture and a first column of pixels from the far left of the I picture are not loop-filtered. Likewise, a first row of pixels from the bottom of the I picture and a first column of pixels from the far right of the I picture are not loop-filtered. In other words, supposing that one frame is comprised of N×M blocks, and each of the blocks has a size of 8×8, seventh and eighth, fifteenth and sixteenth, . . . , and ((N−1)×(8−1))-th and ((N−1)×8)-th rows of pixels are loop-filtered in the process of horizontally loop-filtering the I picture, and seventh and eighth, fifteenth and sixteenth, . . . , and ((N−1)×(8−1))-th and ((N−1)×8)-th columns of pixels are loop-filtered in the process of vertically loop-filtering the I picture.

The order in which the I picture is loop-filtered is very important. Conventionally, pixels near a boundary between every pair of horizontally adjacent subblocks in a frame are loop-filtered, and then pixels near a boundary between every pair of vertically adjacent subblocks in the frame are loop-filtered. The results of loop-filtering the pixels near the boundary between every pair of horizontally adjacent subblocks in the frame should be stored in a memory before loop-filtering the pixels near the boundary between every pair of vertically adjacent subblocks in the frame. This type of non-causal filtering method generally requires a very large memory bandwidth for filtering only one frame. In addition, this type of non-casual filtering method often causes frame delays since the filtering of a predetermined block is not complete until the predetermined block undergoes both horizontal and vertical filtering operations.

2) Loop Filtering of P Picture

P pictures are classified into intra-coded P pictures or inter-coded P pictures. An intra-coded P picture is always subjected to 8×8 transformation. Thus, in the case of an intra-coded P picture, only pixels near a boundary between every pair of vertically or horizontally adjacent 8×8 blocks are loop-filtered. However, an inter-coded P picture can be subjected to 8×8, 8×4, 4×8, or 4×4 inverse transformation in order to decode residual errors. Therefore, in the case of an inter-coded P picture, pixels near a boundary between a block currently being filtered (hereinafter referred to as a current block) and a block vertically or horizontally adjacent to the current block may or may not be loop-filtered depending on the circumstances. Whether to loop-filter the boundary between the current block (or subblock) and the block (or subblock) vertically or horizontally adjacent to the current block (or subblock) is determined according to the following rules:
(1) pixels near a boundary between every pair of vertically or horizontally adjacent subblocks (having a size of 8×4, 4×8, or 4×4) in each block (having a size of 8×8) are loop-filtered; and
(2) pixels near a boundary between each pair of vertically or horizontally adjacent blocks (or subblocks) that have the same motion vector and have no residual errors are not loop-filtered.

FIG. 3 is a diagram illustrating various examples of the loop filtering of a P picture. Specifically, FIG. 3 illustrates in what occasion a boundary between a pair of horizontally adjacent blocks (or subblocks) of a P picture must be loop-filtered. If a pair of horizontally adjacent blocks have the same motion vector, a boundary between the pair of horizontally adjacent blocks is not loop-filtered. Otherwise, the boundary between the pair of horizontally adjacent blocks must be loop-filtered. Referring to FIG. 3, gray blocks (or subblocks) are encoded blocks (or subblocks) with a transformation coefficient, white blocks (or subblocks) are blocks with no transformation coefficient, a thick solid line represents a boundary between a pair of vertically or horizontally adjacent blocks (or subblocks) that is loop-filtered, and a thin solid line represents a boundary between a pair of vertically or horizontally adjacent blocks (or subblocks) that is not loop-filtered. Whether to loop-filter a boundary between a pair of vertically or horizontally adjacent blocks (or subblocks) of a P picture is determined according to the above-mentioned rules. FIG. 3 illustrates the loop filtering of only pairs of horizontally adjacent blocks of a P picture. However, whether to loop-filter a boundary between a pair of vertically adjacent blocks of a P picture can be determined according to the same rules that are used to determine whether to loop-filter a boundary between a pair of horizontally adjacent blocks of the P picture. The above description may also be applied to the loop-filtering of horizontal block (or horizontal subblock) boundaries of the P picture.

FIGS. 4(a) and 4(b) are diagrams illustrating the horizontal loop filtering and vertical loop filtering, respectively, of a P picture. Referring to FIG. 4(a), a boundary between every pair of vertically adjacent 8×8 blocks and a boundary between every pair of vertically adjacent 8×4 subblocks, i.e., fourth and fifth, eighth and ninth, twelfth and thirteenth rows of pixels in a P picture, can be loop-filtered.

Referring to FIG. 4(b), a boundary between every pair of horizontally adjacent 8×8 blocks and a boundary between every pair of horizontally adjacent 4×8 subblocks, i.e., fourth and fifth, eighth and ninth, and twelfth and thirteenth columns of pixels in the P picture, can be loop-filtered. Pixels adjoining outlines of the P picture, i.e., a first row of pixels from the top and bottom of the P picture and a first column of pixels from the far left and far right of the P picture, like a first row of pixels from the top and bottom of an I picture and a first column of pixels from the far left and far right of the I picture, are excluded from the loop-filtering of the P picture.

The order in which a P picture is loop-filtered is also very important. First, a boundary between every pair of vertically adjacent blocks in a frame is loop-filtered in an order from the top to the bottom of the P picture, and the loop-filtering results are stored in a memory. Thereafter, a boundary between every pair of vertically adjacent 8×4 subblocks in the frame is loop-filtered in the order from the top to the bottom of the P picture, and the loop-filtering results are stored in the memory. Thereafter, a boundary between every pair of horizontally adjacent 8×8 blocks in the frame is loop-filtered from the left to the right of the P picture, and the loop-filtering results are stored in the memory. Thereafter, a boundary between every pair of horizontally adjacent 4×8 subblocks in the frame is loop-filtered in the order from the left to the right of the P picture, and the loop-filtering results are stored in the memory. Therefore, the boundary between every pair of vertically blocks or subblocks is loop-filtered in 2 stages, and then the boundary between every pair of horizontally adjacent blocks or subblocks is loop-filtered in 2 stages. Thus, each frame is loop-filtered in a total of 4 stages. In this regard, this type of non-causal filtering method is believed to cause frame delays and to require a large memory bandwidth.

3) Loop-Filtering of B Picture

A B picture is loop-filtered in the same manner as an I picture.

Loop-filtering of a boundary between every pair of vertically or horizontally adjacent blocks (or subblocks) will be described in the following in further detail.

FIGS. 5(a) and 5(b) are diagrams illustrating the loop filtering of pixels near a boundary between a pair of vertically or horizontally adjacent blocks. Since each block or subblock is comprised of a multiple of 4 pixels lengthwise or widthwise, a vertical or horizontal loop filtering operation should be performed in units of a multiple of four pixels. Referring to FIG. 5(a), two columns of pixels are divided into four segments each comprised of 4 pixels so that a boundary between a pair of vertically adjacent blocks (or subblocks) falls between the two upper segments and the two lower segments. A third pixel from the top of each of the segments, which is marked by ‘X’, is loop-filtered ahead of the rest of the pixels of a corresponding segment. Thereafter, it is determined whether to loop-filter the pixels of the corresponding segment except for the third pixel based on the result of loop-filtering the third pixel of the corresponding section. Specifically, if the result of loop-filtering the third pixel of the corresponding section shows that a blocking phenomenon has not yet occurred and thus it is determined not to perform a loop filtering operation any longer, none of the pixels of the corresponding section except for the third pixel are loop-filtered.

Referring to FIG. 5(b), suppose that a boundary between a pair of horizontally adjacent blocks or subblocks falls between fourth and fifth pixels P4 and P5. The fourth and fifth pixels P4 and P5 are exchangeable in the process of filtering. The value of the fifth pixel P4 and the values of first through third pixels P1 through P3, which are on the left side of the pixel P4, are weight-averaged, thereby obtaining a first compensation value. Likewise, the value of the pixel P5 and the values of sixth through eight pixels P6 through P8, which are on the right side of the pixel P5, are weight-averaged, thereby obtaining a second compensation value. Thereafter, the first and second compensation values are added to or subtracted from the values of the pixels P4 and P5. In this manner, it is possible to prevent or minimize block artifacts rendered around a boundary between every pair of vertically or horizontally adjacent blocks or subblocks.

Referring to FIG. 5(a), if the result of loop-filtering the third pixel of the corresponding segment shows that the rest of the pixels of the corresponding segment need to be loop-filtered, all the pixels of the corresponding section except for the third pixel are loop-filtered. Otherwise, the loop filtering of all the pixels of the corresponding segment except for the third pixel is skipped, and another iteration of loop filtering is performed on a segment subsequent to the corresponding segment.

An overlap smoothing operation will now be described in detail.

FIG. 6 is a diagram illustrating an example of an overlap smoothing operation. Referring to FIG. 6, if OVERLAP, which is a sequence parameter, is set to 1 and predetermined conditions are met, a filtering operation dubbed overlap smoothing may be performed on a boundary between a pair of two vertically or horizontally adjacent intra blocks each having YCbCr. An overlap smoothing operation, also called an overlap transformation operation, is performed ahead of a loop filtering operation described above with reference to FIGS. 2(a) through 5(b). An overlap smoothing operation is a type of block-based transformation that causes a pair of vertically or horizontally adjacent blocks to exchange their boundary information with each other. A well-designed overlap smoothing operation helps minimize blocking noise.

FIG. 6 illustrates a P frame containing a plurality of I blocks. Referring to FIG. 6, pixels, which may be Y or CbCr, are rendered as small squares, I blocks are rendered as large rectangles filled with hatching, and P blocks are rendered as areas filled with dots. Only the areas filled with dots are overlap-smoothed. Specifically, two columns or rows of pixels at either side of a boundary between horizontally or vertically adjacent 2×2 P blocks are overlap-smoothed. Pixels included in a circle are both horizontally and vertically overlap-smoothed.

An overlap smoothing operation is performed on a pair of horizontally adjacent pixels a0 and a1 and a pair of horizontally adjacent pixels b1 and b0. The two pairs of horizontally adjacent pixels a0 and a1, and b1 and b0 are adjacent to each other and have a boundary therebetween. The pixels a0 and a1 are on the left side of the boundary, and the pixels b1 and b0 are on the right side of the boundary. Thereafter, an overlap smoothing operation is performed on a pair of vertically adjacent pixels p0 and p1 and a pair of vertically adjacent pixels q1 and q0. The two pairs of vertically adjacent pixels p0 and p1, and q1 and q0 are adjacent to each other and have a boundary therebetween. In other words, the pixels a0, a1, b1, and b0 are overlap-smoothed, and then the pixels p0, p1, q1, and q0 are overlap-smoothed. The results of overlap-smoothing the pixels a0, a1, b1, and b0 are stored in a memory before overlap-smoothing the pixels p0, p1, q1, and q0.

Whether to perform an overlap smoothing operation on an I, P, or B frame is determined based on whether predetermined conditions are met. The predetermined conditions are described in detail in VC-1-related documents, and thus their detailed descriptions will be skipped. Unless the predetermined conditions are met, an overlap smoothing operation may be skipped. For example, an overlap smoothing operation may not be performed on a frame which is comprised of only inter blocks. However, for the convenience of explanation, it is assumed in this disclosure that both an overlap smoothing operation and a loop filtering operation need to be performed. However, it is obvious that an overlap smoothing operation may be skipped based on whether the predetermined conditions are met.

As described above, a conventional VC-1 filtering method and apparatus performs a horizontal overlap smoothing operation and then a vertical overlap smoothing operation in units of frames or slices and then performs a horizontal loop filtering operation and then a vertical loop filtering operation in units of the frames or slices in order to prevent a blocking phenomenon. Accordingly, the conventional VC-1 filtering method and apparatus need to store a result of performing a horizontal overlap smoothing operation before performing a vertical overlap smoothing operation and to store a result of performing a horizontal loop filtering operation before performing a vertical loop filtering operation. Therefore, the VC-1 filtering method and apparatus require large memory bandwidth and a number of frame memories and is likely to cause frame delays and require a frame memory with a larger storage capacity. In addition, it is difficult to realize codec hardware using the conventional VC-1 filtering method and apparatus due to the non-causal characteristics of the conventional VC-1 filtering method and apparatus.

### SUMMARY OF THE INVENTION

Additional aspects, features, and/or advantages of the invention will be set forth in part in the description which follows and, in part, will be apparent from the description, or may be learned by practice of the invention.

The present invention provides a filtering method, apparatus, and medium used in an audio-video codec, which can overcome the non-causality of an overlap smoothing operation and a loop filtering operation and can efficiently perform the overlap smoothing operation and the loop filtering operation without the need to expand a memory or bandwidth.

According to an aspect of the present invention, there is provided a filtering method used in an audio-video codec. The filtering method includes: determining a predetermined macroblock as a filtering region; expanding the filtering region to further include a portion of a macroblock adjacent to the predetermined macroblock near a boundary between the predetermined macroblock and the macroblock adjacent to the predetermined macroblock; and performing a deblocking filtering operation on the expanded filtering region in a causal manner according to the passage of time.

In the performing of the de-blocking filtering operation, the expanded filtering region may be horizontally and then vertically deblocking-filtered, and then a filtering region subsequent to the expanded filtering region may be horizontally and then vertically deblocking-filtered.

The portion of the macroblock adjacent to the predetermined macroblock may include a plurality of segments each comprised of at least 4 pixels.

The deblocking filtering operation may include at least one of an overlap smoothing operation and a loop filtering operation.

The expanded filtering region may be overlap-smoothed in units of macroblocks, if predetermined conditions are met, and then loop-filtered in units of the macroblocks.

The expanded filtering region may be overlap-smoothed using at least two rows or columns of pixels at either side of a boundary between every pair of adjacent subblocks of a macroblock included in the expanded filtering region.

Pixels near a boundary between two pairs of vertically adjacent 8×8 blocks of a macroblock included in the expanded filtering region may be horizontally overlap-smoothed and then vertically overlap-smoothed.

The expanded filtering region may be loop-filtered using at least four rows or columns of pixels at either side of the boundary between every pair of adjacent subblocks of a macroblock included in the expanded filtering region.

Pixels near a boundary between two pairs of horizontally adjacent 8×8 blocks of a macroblock included in the expanded filtering region may be horizontally loop-filtered, pixels near a boundary between every pair of horizontally adjacent 8×4 subblocks of the macroblock included in the expanded filtering region may be horizontally loop-filtered, pixels near a boundary between two pairs of vertically adjacent 8×8 blocks of the macroblock included in the expanded filtering region may be vertically loop-filtered, and pixels near a boundary between every pair of vertically adjacent 4×8 subblocks of the macroblock included in the expanded filtering region may be vertically loop-filtered.

The audio-video codec may follow VC-1 submitted to the Society of Motion Picture and Television Engineers (SMPTE).

According to another aspect of the present invention, there is provided a filtering apparatus used in an audio-video codec. The filtering apparatus includes: a buffer unit, which stores a predetermined macroblock as a filtering region; a row buffer, which stores a portion of a macroblock vertically adjacent to the predetermined macroblock near a boundary between the predetermined macroblock and the macroblock vertically adjacent to the predetermined macroblock; a column buffer, which stores a portion of a macroblock horizontally adjacent to the predetermined macroblock near a boundary between the predetermined macroblock and the macroblock horizontally adjacent to the predetermined macroblock; and a filtering unit, which performs a deblocking filtering operation on the filtering region stored in the buffer unit in a causal manner according to the passage of time.

According to another aspect of the present invention, there is provided at least one computer readable medium storing instructions that control at least one processor to perform a method including determining a predetermined macroblock as a filtering region; expanding the filtering region to further include a portion of a macroblock adjacent to the predetermined macroblock near a boundary between the predetermined macroblock and the macroblock adjacent to the predetermined macroblock; and performing a deblocking filtering operation on the expanded filtering region in units of macroblocks according to a passage of time.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a block diagram of a VC-1 decoder;

FIGS. 2(a) and 2(b) are diagrams illustrating the loop-filtering of pixels near boundaries between two vertically adjacent blocks of an I picture and between two horizontally adjacent blocks of the I picture;

FIG. 3 is a diagram illustrating various examples of loop-filtered block boundaries of a P picture;

FIGS. 4(a) and 4(b) are diagrams illustrating the loop-filtering of pixels near boundaries between two vertically adjacent blocks (or subblocks) of a P picture and between two horizontally adjacent blocks (or subblocks) of the P picture;

FIGS. 5(a) and 5(b) are diagrams illustrating the loop-filtering of pixels near a boundary between two adjacent blocks;

FIG. 6 is a diagram illustrating an overlap smoothing operation;

FIG. 7 is a block diagram of a filtering apparatus according to an exemplary embodiment of the present invention;

FIG. 8 is a diagram illustrating a frame to be filtered using a filtering method according to an exemplary embodiment of the present invention;

FIG. 9 is a diagram illustrating the overlap smoothing and loop filtering of CASE 1 of FIG. 8, according to an exemplary embodiment of the present invention;

FIGS. 10A through 10B are diagrams illustrating the overlap smoothing and loop filtering of CASE 2 of FIG. 8, according to an exemplary embodiment of the present invention;

FIGS. 11A and 11B are diagrams illustrating the overlap smoothing and loop filtering of CASE 3 of FIG. 8, according to an exemplary embodiment of the present invention; and

FIGS. 12A through 12C are diagrams illustrating the overlap smoothing and loop filtering of CASE 4 of FIG. 8, according to an exemplary embodiment of the present invention.

### DETAILED DESCRIPTION OF THE PREFERRED EMBODIMENTS

Reference will now be made in detail to exemplary embodiments of the present invention, examples of which are illustrated in the accompanying drawings, wherein like reference numerals refer to the like elements throughout. Exemplary embodiments are described below to explain the present invention by referring to the figures.

The present invention will now be described more fully with reference to the accompanying drawings in which exemplary embodiments of the present invention are shown.

FIG. 7 is a block diagram of a filtering apparatus according to an exemplary embodiment of the present invention. Referring to FIG. 7, the filtering apparatus, unlike a conventional VC-1 filtering apparatus, performs a filtering operation on a picture in units of macroblocks. Accordingly, the filtering apparatus includes a row buffer 630 and a column buffer 640 in which macroblock boundary information is temporarily stored.

Specifically, the filtering apparatus includes a filter unit 610 which prevents a blocking phenomenon, a buffer unit (L_BUF) 620 which store data to be filtered and results of filtering the data to be filtered, and the row buffer (ROW_BUF) 630 and the column buffer (COL_BUF) 640 which temporarily store macroblock boundary information.

A minimum unit of data that can be processed according to the present invention is a 16×16 macroblock. Accordingly, the filtering apparatus according to an exemplary embodiment of the present invention is designed to perform an overlap smoothing operation and a loop filtering operation in units of 16×16 macroblocks. In other words, the filtering apparatus according to an exemplary embodiment of the present invention performs an overlap smoothing operation on each 16×16 macroblock of a frame and then performs a loop filtering operation on each 16×16 macroblock of the frame. The buffer unit 620, which is a buffer having a size of 16×16, stores results of filtering each 16×16 macroblock of the frame. The row buffer 630, which is a buffer having a size of 20×8, stores pixels of a macroblock currently being filtered (hereinafter referred to as a current macroblock) near a boundary between the current macroblock and a macroblock located right above the current macroblock and results of filtering the pixels stored therein. The column buffer 640, which is a buffer having a size of 8×16, stores pixels of the current macroblock near a boundary between the current macroblock and a macroblock located on the left side of the current macroblock and results of filtering the pixels stored therein.

The operation of the filtering apparatus according to the exemplary embodiment of the present invention will now be described in further detail on the assumption that a frame to be filtered is comprised of 4 macroblocks lengthwise and 3 macroblocks widthwise.

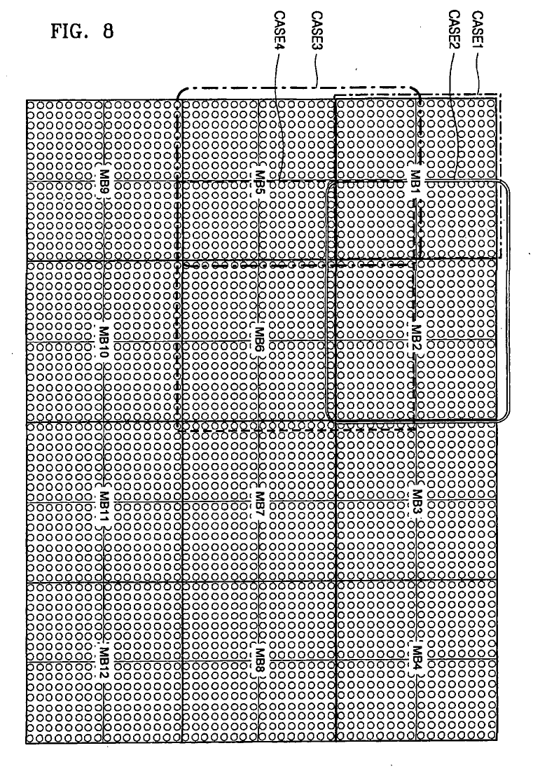

FIG. 8 is a diagram illustrating a frame to be overlap-smoothed and then loop-filtered according to an exemplary embodiment of the present invention. Referring to FIG. 8, the frame is comprised of 12 macroblocks, i.e., first through twelfth macroblocks MB1 through MB12. CASE 1 indicates a region that is to be filtered and includes the first macroblock MB1, and CASE 2 indicates a region that is to be filtered and includes the second macroblock MB2. CASE 3 indicates a region that is to be filtered and includes the fifth macroblock MB5, and CASE 4 indicates a region that is to be filtered and includes the sixth macroblock MB6.

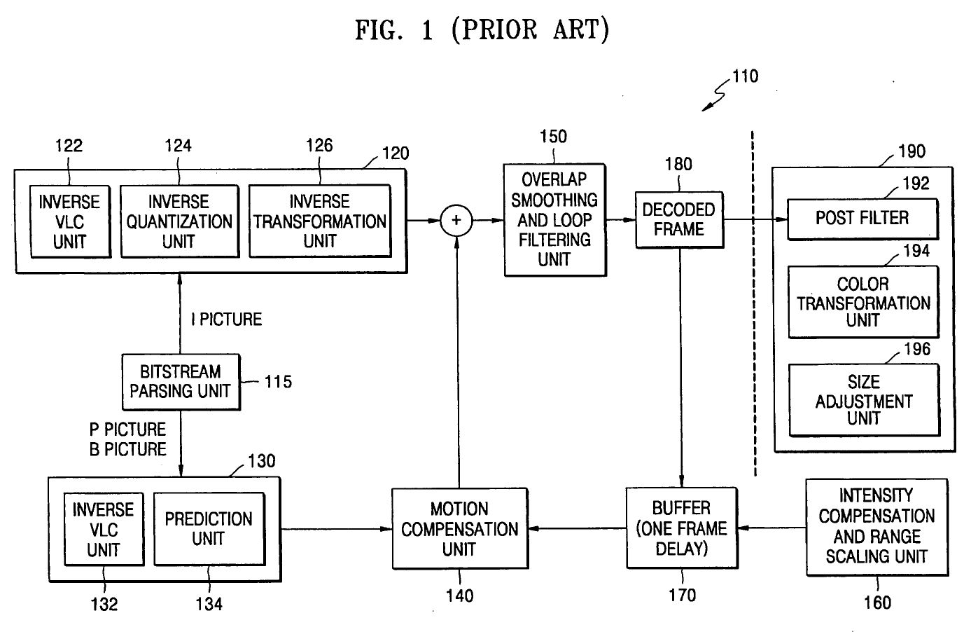

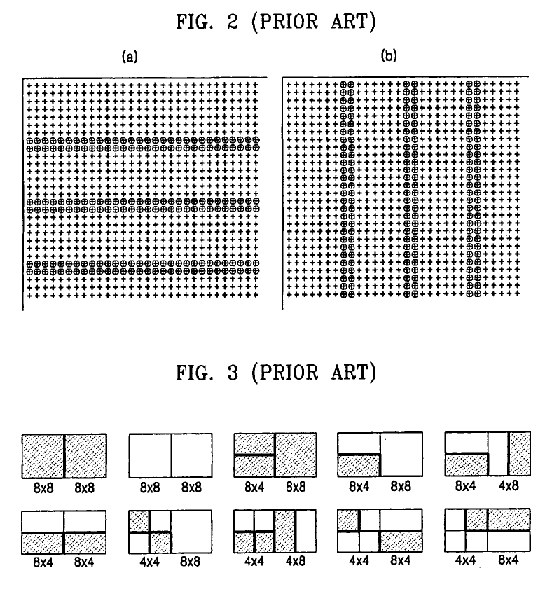

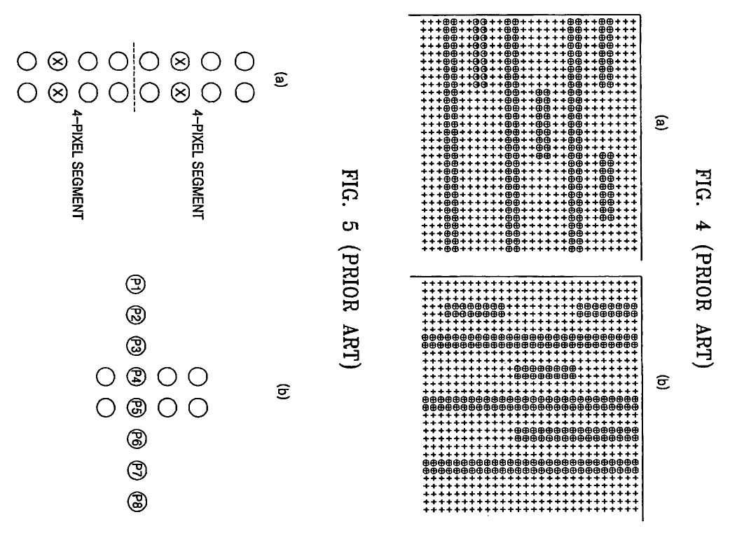

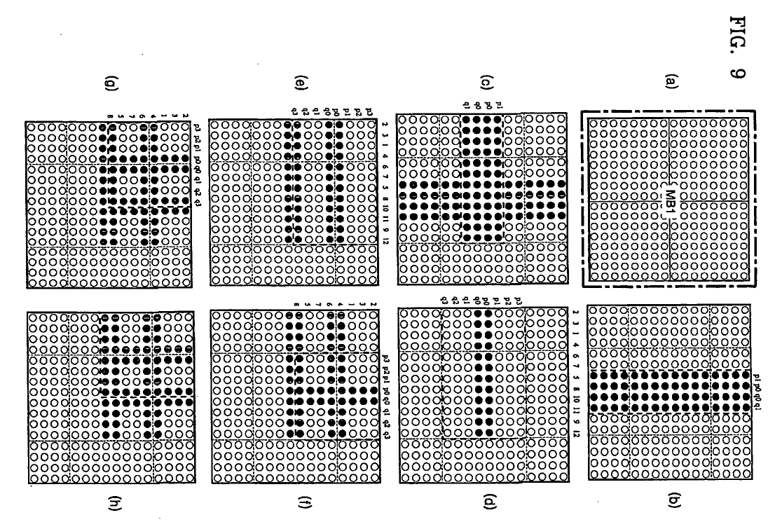

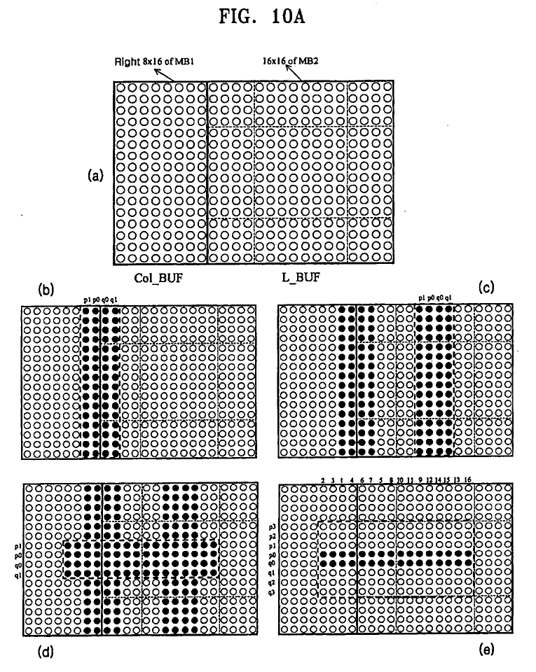

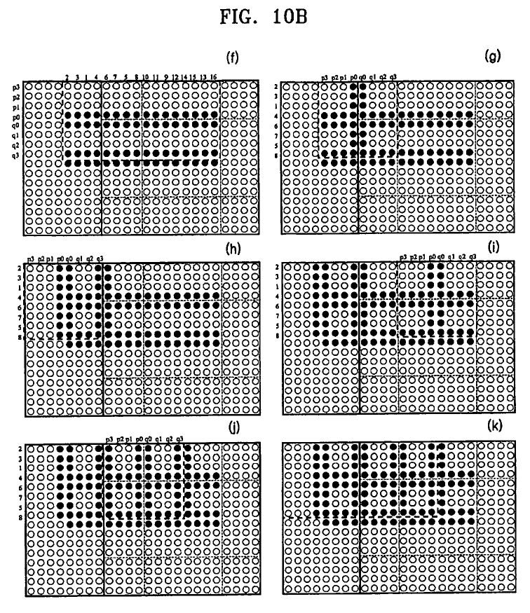

FIG. 9 is a diagram illustrating the overlap smoothing and loop filtering of CASE 1 of FIG. 8, according to an exemplary embodiment of the present invention. Referring to FIG. 9, the first macroblock MB1 is motion-compensated in the same manner as described above with reference to FIG. 1. Thereafter, the motion-compensated first macroblock MB1 is overlap-smoothed and then loop-filtered.

Referring to FIGS. 7 and 9, the motion-compensated first macroblock MB1 is stored in the buffer unit 620. Thereafter, it is determined whether to overlap-smooth the motion-compensated first macroblock MB1 based on whether the predetermined conditions that have already been described above are met. If the predetermined conditions are not met, the motion-compensated first macroblock MB1 is directly loop-filtered without being overlap-smoothed. Otherwise, the motion-compensated first macroblock MB1 is overlap-smoothed and then loop-filtered, which will now be described in further detail.

FIG. 9(a) illustrates CASE 1. Since the first macroblock MB1 is a first macroblock of a first slice of the frame of FIG. 8, the row buffer 630 and the column buffer 640 are empty. Pixels that adjoin a boundary between the first and second macroblocks MB1 and MB2 are filtered when a filtering operation is performed on the second macroblock MB2.

The overlap smoothing of the first macroblock MB1 will now be described in detail with reference to FIGS. 9(b) and 9(c).

Referring to FIG. 9(b), 2 columns of pixels at either side of a boundary between 2 pairs of vertically adjacent blocks of the first macroblock MB1, which are rendered as black circles and enclosed by two parallel dotted lines, are overlap-smoothed. Specifically, seventh through tenth pixels in each row of the first macroblock MB1 are simultaneously input to latches p1, p0, q0, and q1, respectively, of FIG. 7. Each row of the first macroblock MB1 is input from the respective latches to the filter unit 610 in synchronization with a clock cycle. Thereafter, output values of the filter unit 610, which performs an overlap smoothing operation on the first macroblock MB1, are input to registers P1, P0, Q0, and Q1. The buffer unit 620 updates values previously received from the latches P1, P0, Q0, and Q1 based on output values of the latches P1, P0, Q0, and Q1. The buffer unit 620 updates the values previously input from the registers P1, P0, Q0, and Q1 only for portions of the first macroblock MB1 that satisfy the predetermined conditions.

Referring to FIG. 9(c), 2 rows of pixels from a boundary between 2 pairs of horizontally adjacent 8×8 blocks in the first macroblock MB1 excluding those not enclosed by a dotted line are rendered as black circles. Only the pixels rendered as black circles are overlap-smoothed in the same manner as the 2 rows of pixels from the boundary between the 2 pairs of vertically adjacent 8×8 blocks of the first macroblock MB1, as illustrated in FIG. 9(b). The pixels that are not enclosed by the dotted line but adjoin the boundary between the 2 pairs of horizontally adjacent 8×8 blocks of the first macroblock MB1 are filtered when a filtering operation is performed on the second macroblock MB2. Alternatively, at least 2 columns of pixels from the far right side of the first macroblock MB1 may be filtered when a filtering operation is performed on the second macroblock MB2.

Once the over-smoothing of the first macroblock MB1 is complete, a loop-filtering operation is performed on the first macroblock MB1. Referring to FIG. 9(d), pixels adjoining the boundary between the 2 pairs of horizontally adjacent 8×8 blocks excluding those not enclosed by a dotted line are rendered as black circles. Only the pixels rendered as black circles are loop-filtered. Pixels of the first macroblock MB1 that adjoin a boundary between the first macroblock MB1 and the fifth macroblock MB5 are loop-filtered when a filtering operation is performed on the fifth macroblock MB5. The pixels that are not enclosed by the dotted line but adjoin the boundary between the 2 pairs of horizontally adjacent 8×8 blocks of the first macroblock MB1 are loop-filtered when a filtering operation is performed on the second macroblock MB2. Pixels that do not adjoin the boundary between the 2 pairs of horizontally adjacent 8×8 blocks but are enclosed by the dotted line are used for loop-filtering the pixels rendered as black circles.

Referring to FIG. 9(d), a total of 12 columns of pixels enclosed by the dotted line are input to the latches p0, p1, p2, p3, q0, q1, q2, and q3 of FIG. 7 so that 8 pixels in each of the 12 columns are simultaneously input to the respective latches. Each of the 12 columns enclosed by the dotted line is comprised of 8 pixels. Specifically, the first through twelfth pixels in the first through fourth rows of the first macroblock MB1 excluding those not enclosed by the dotted line are input to the latches p3, p2, p1, and p0 in such a manner that 4 pixels are simultaneously input to the respective latches, and the first through twelfth pixels in the fifth through eighth rows excluding those not enclosed by the dotted line are input to the latches q0, q1, q2, and q3 in such a manner that 4 pixels are simultaneously input to the respective latches.

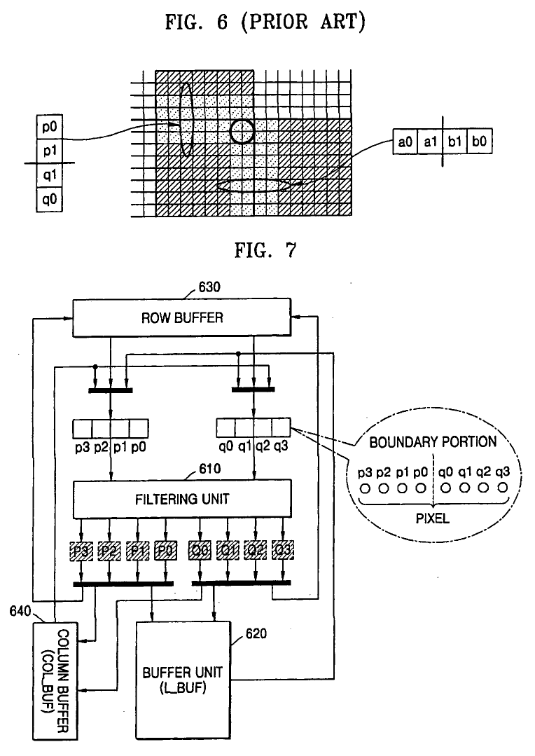

A total of 12 pixels included in each of a total of 8 rows enclosed by the dotted line are numbered, as shown on top of FIG. 9(d), according to the order in which they are input to a corresponding latch (p3, p2, p1, p0, q0, q1, q2, or q4). Supposing that each of the 8 rows enclosed by the dotted line is divided into 3 sections each comprised of 4 pixels, a third pixel in each of the 3 sections (i.e., the third, seventh, and eleventh pixels in each of the eight rows enclosed by the dotted line) is loop-filtered ahead of the rest of the pixels in a corresponding section, as described above. Thereafter, it is determined whether to loop-filter the rest of the pixels in the corresponding section based on a result of loop-filtering the third pixel in the corresponding section. Thereafter, the eight rows of pixels enclosed by the dotted line are output from the respective latches and then are sequentially input to the filter unit 610 of FIG. 6 over one cycle and loop-filtered. The loop filtering of the twelve columns of pixels or the eight rows of pixels enclosed by the dotted line is performed in the same manner described above with reference to FIG. 5. Here, the eight rows of pixels enclosed by the dotted line may be loop-filtered using any filtering method defined in VC-1. As a result of loop-filtering the eight rows of pixels enclosed by the dotted line, the values of the pixels rendered as black circles are input to the latches P0 and Q0 of FIG. 7. If there is a need to perform a filtering operation, e.g., if the horizontal or vertical block boundaries in the macroblock MB, rather than the outlines of the first macroblock MB1, are mistakenly rendered as boundaries of the first macroblock MB1, the buffer unit 620 updates the values previously received from the latches P0 and Q0 based on the values currently received from the latches P0 and Q0.

Likewise, fifth through eighth pixels in each of the eight rows enclosed by the dotted line are filtered, and then ninth through twelfth pixels in each of the eight rows enclosed by the dotted line are filtered. All of the eight rows of pixels enclosed by the dotted line may be loop-filtered, but the buffer unit 620 updates the values previously received from the latches P0 and Q0 based on the results of loop-filtering the pixels that are rendered as black circles in FIG. 9(d), i.e., the pixels that adjoin the boundary between the 2 pairs of horizontally adjacent 8×8 blocks of the first macroblock MB1. For example, in the case of loop-filtering an I picture, the buffer unit 620 updates data stored in a memory only for pixels adjoining a boundary between adjacent 8×8 blocks, and in the case of loop-filtering a P picture, the buffer unit 620 updates the data stored in the memory only for pixels adjoining a boundary between coded blocks.

FIG. 9(e) illustrates the loop filtering of pixels adjoining the boundary between the 2 pairs of horizontally adjacent 8×4 subblocks of the first macroblock MB1. Referring to FIG. 9(e), the pixels adjoining the boundary between the 2 pairs of horizontally adjacent 8×4 subblocks of the first macroblock MB1 are rendered as black circles. All of a plurality of pixels enclosed by the dotted line except for the pixels rendered as black circles are used for loop-filtering the pixels rendered as black circles. The pixels rendered as black circles are loop-filtered in the same manner as described above with reference to FIG. 9(d). According to VC-1, if the first macroblock MB1 is an intra block, the loop filtering of the pixels rendered as black circles may be skipped.

If the loop-filtering of the pixels adjoining horizontal block boundaries in the first macroblock MB1 is complete, pixels adjoining vertical block boundaries are loop-filtered, which will be described in the following with reference to FIGS. 9(f), 9(g), and 9(h).

Referring to FIG. 9(f), the pixels that adjoin the boundary between the 2 pairs of vertically adjacent 8×8 blocks of the first macroblock MB1 excluding those not enclosed by 2 parallel dotted lines, are loop-filtered. The pixels that are not enclosed by the 2 parallel dotted lines but adjoin the boundary between the two pairs of vertically adjacent 8×8 blocks of the first macroblock MB1 are filtered when a filtering operation is performed on the fifth macroblock MB5. In addition, the 4 columns of pixels from the far right side of the first macroblock MB1 are filtered when a filtering operation is performed on the second macroblock MB2. The pixels that do not adjoin the boundary between the 2 pairs of vertically adjacent 8×8 blocks of the first macroblock MB1 but are enclosed by the 2 dotted lines are used for loop-filtering the pixels rendered as black circles.

Referring to FIG. 9(g), two pairs of vertically adjacent 4×8 subblocks in an upper left 8×8 block of the first macroblock MB1 are loop-filtered in the same manner as described above with reference to FIGS. 9(d) and 9(e). According to VC-1, if the first macroblock MB1 is an intra block, the loop-filtering of two pairs of vertically adjacent 4×8 subblocks in the upper left 8×8 block of the first macroblock MB1 may be skipped.

A result of loop-filtering the first macroblock MB1 is temporarily stored in the buffer unit 620 and then is recorded in an external frame memory. FIG. 9(h) illustrates the result of loop-filtering the first macroblock MB1, which is recorded in the external frame memory.

Thereafter, the values of pixels included in upper and lower right 8×8 blocks of the first macroblock MB1 are loaded into the column buffer 640, and the values of pixels included in the second macroblock MB2 are loaded into the buffer unit 620 in order to perform an overlap smoothing operation and then a loop filtering operation on CASE 2 (refer to FIG. 7).

As described above, an overlap smoothing operation and a loop filtering operation are performed in units of segments each comprised of 4 pixels. In addition, a macroblock is vertically overlap-smoothed and then horizontally overlap-smoothed. After the overlap smoothing of the macroblock is complete, the macroblock is horizontally loop-filtered and then vertically loop-filtered.

FIGS. 10A and 10B are diagrams illustrating the overlap smoothing and loop filtering of CASE 2 of FIG. 8, particularly, the overlap smoothing and loop filtering of the second macroblock MB2, according to an exemplary embodiment of the present invention. Specifically,

FIG. 10A(a) illustrates CASE 2 to be overlap-smoothed and loop-filtered. Referring to FIG. 10A(a), CASE 2 includes not only the second macroblock MB2 but also the upper and lower right 8×8 blocks of the first macroblock MB1. As described above, the values of the pixels included in the upper and lower right 8×8 blocks of the first macroblock MB1 are temporarily stored in the column buffer 640.

Referring to FIGS. 10A(b) through 10A(d), two arrays of pixels at either side of a boundary between the first and second macroblocks MB1 and MB2 are overlap-smoothed, two arrays of pixels at either side of a boundary between two pairs of vertically adjacent 8×8 blocks of the second macroblock MB2 are overlap-smoothed, and then two arrays of pixels at either side of a boundary between a pair of vertically adjacent 4×8 subblocks in the far right side of the first macroblock MB1 and two arrays of pixels at either side of a boundary between two pairs of horizontally adjacent 8×8 blocks of the second macroblock MB2 except for those included in a pair of vertically adjacent 4×8 subblocks in the far right side of the second macro MB2 are overlap-smoothed. The overlap smoothing of CASE 2 is the same as the overlap smoothing of CASE 1 described above with reference to FIGS. 9(b) and 9(c). Referring to FIG. 10(d), four columns of pixels from the far left of CASE 2 have already been overlap-smoothed when overlap-smoothing CASE 1, and four columns of pixels from the far right of CASE 2 are to be overlap-smoothed when overlap-smoothing the third macroblock MB3. Thus, these eight columns of pixels are excluded from the overlap-smoothing of CASE 2.

If the overlap smoothing of CASE 2 is complete, CASE 2 is loop-filtered. Referring to FIG. 10A(e), of a plurality of pixels that adjoin a boundary between the upper and lower right 8×8 blocks of the first macroblock MB1 or the boundary between the two pairs of horizontally adjacent 8×8 blocks of the second macroblock MB2, only those rendered as black circles are loop-filtered. Eight rows of pixels from the bottom of CASE 2 and the four columns of pixels from the far right of CASE 2 are to be loop-filtered when loop-filtering a subsequent slice or a subsequent macroblock. All of a plurality of pixels enclosed by a dotted line except for the pixels rendered as black circles are used for loop-filtering the pixels rendered as black circles. In other words, a total of eight rows enclosed by the dotted line are input to the latches p3, p2, p1, p0, q0, q1, q2, and q3 and then loop-filtered. Each of the eight rows enclosed by the dotted line is comprised of 16 pixels in the same manner as described above with reference to FIGS. 9(d) through 9(h). Thereafter, referring to FIG. 10B(f), of a plurality of pixels included in two pairs of horizontally adjacent 4×8 subblocks enclosed by a dotted line, the pixels that adjoin a boundary between the two pairs of horizontally adjacent 4×8 subblocks are loop-filtered in the same manner as described above.

FIGS. 10B(g) through 10B(k) illustrate the vertical loop-filtering of CASE 2. Referring to FIG. 10B(g), a total of eight columns enclosed by a dotted line are input to the latches p3, p2, p1, p0, q0, q1, q2, and q3 and then loop-filtered in almost the same manner as described above with reference to FIG. 5. Each of the eight columns is comprised of 8 pixels. The eight pixels included in each of the eight columns are numbered as shown on the left side of FIG. 10B(g) according to an order in which they are input to a corresponding latch.

Thereafter, eight columns enclosed by a dotted line of FIG. 10B(h), eight columns enclosed by a dotted line of FIG. 10B(i), and eight columns enclosed by a dotted line of FIG. 10B(j) are sequentially loop-filtered in the same manner as described above with reference to FIG. 10B(g). FIG. 10B(k) illustrates a result of loop-filtering CASE 2, which is recorded in the external frame memory.

Thereafter, the values of pixels included in eight columns from the far right of the second macroblock MB2 are loaded into the column buffer 640, and the values of pixels included in the third macroblock MB3 to be filtered in a subsequent iteration are loaded into the buffer unit 620. In this manner, the first slice comprised of the first through fourth macroblocks MB1 through MB4 is filtered.

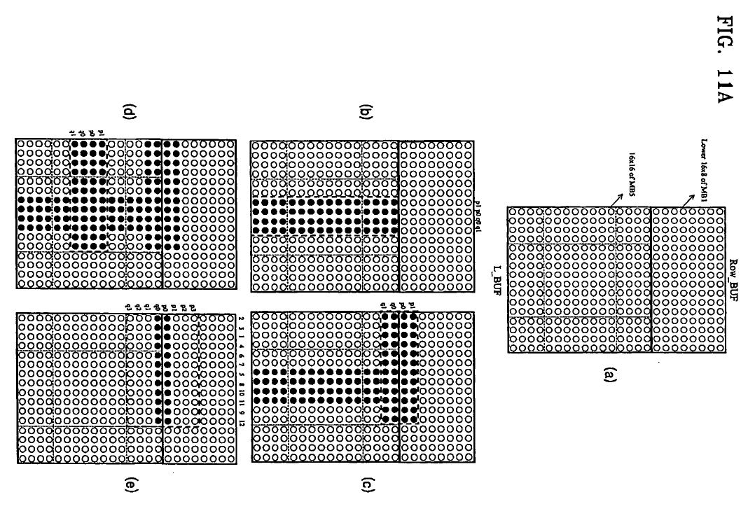

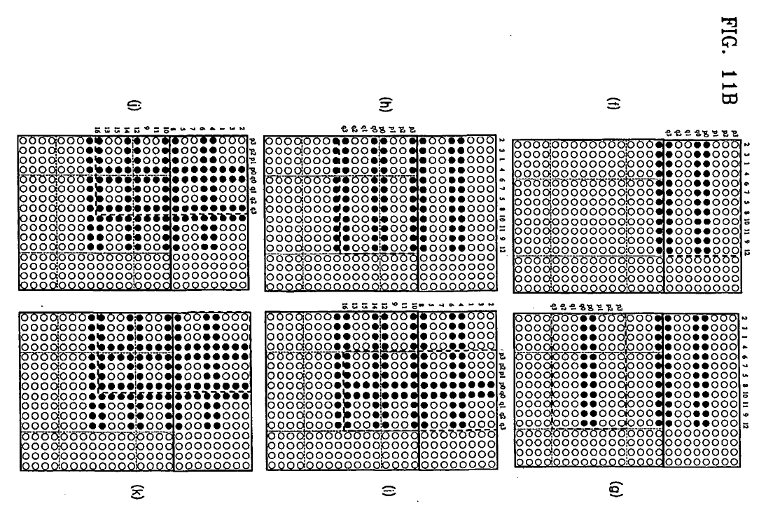

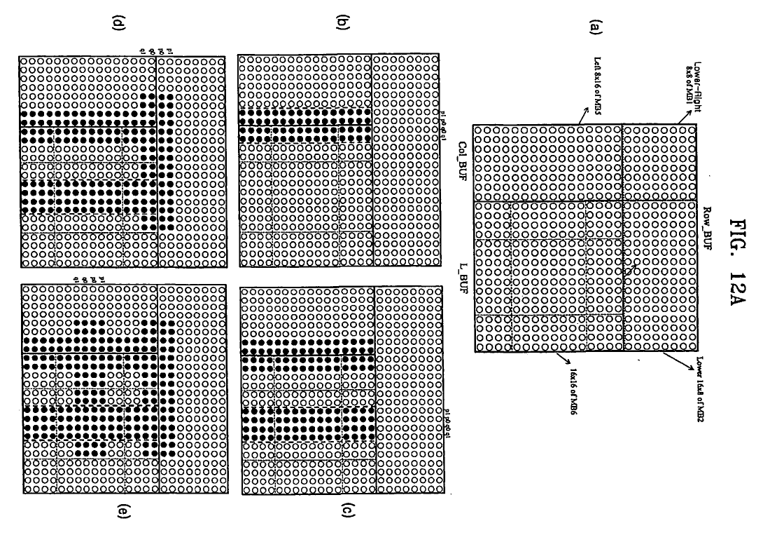

FIGS. 11A and 11B are diagrams illustrating the overlap smoothing and loop filtering of CASE 3 of FIG. 8, according to an exemplary embodiment of the present invention. Specifically, FIGS. 11A and 11B illustrate the overlap smoothing and loop filtering of the fifth macroblock MB5, which is a first macroblock of a second slice. After the overlap smoothing and loop filtering of the fourth macroblock MB4 are complete, the values of pixels included in 8 upper rows from the bottom of the first macroblock MB1 are loaded into the row buffer 630, and the values of pixels included in the fifth macroblock MB5 are loaded into the buffer unit 620.

The overlap smoothing of CASE 3 is illustrated in FIGS. 11A(b) through 11A(d). Referring to FIGS. 11A(b) through 11A(d), CASE 3 is overlap-smoothed in the same manner as described above with reference to FIGS. 9, 10A, or 10B.

The loop filtering of CASE 3 is illustrated in FIGS. 11A(e), 11B(f) through 11B(h). Referring to FIGS. 11A(e), 11B(f) through 11B(h), CASE 3 is loop-filtered in the same manner as described above with reference to FIGS. 9, 10A, or 10B. A result of loop-filtering CASE 3 is illustrated in FIGS. 11B(i) and 11B(j), and a result of overlap-smoothing and then loop-filtering CASE 3 is illustrated in FIG. 11B(k). The result of overlap-smoothing and then loop-filtering CASE 3 is recorded in the external frame memory.

Pixel values stored in the buffer unit 620, the row buffer 630, and the column buffer 640 are updated for a subsequent iteration of filtering. The updated pixel values do not belong to pixels yet to be filtered but belong to pixels that have already been filtered.

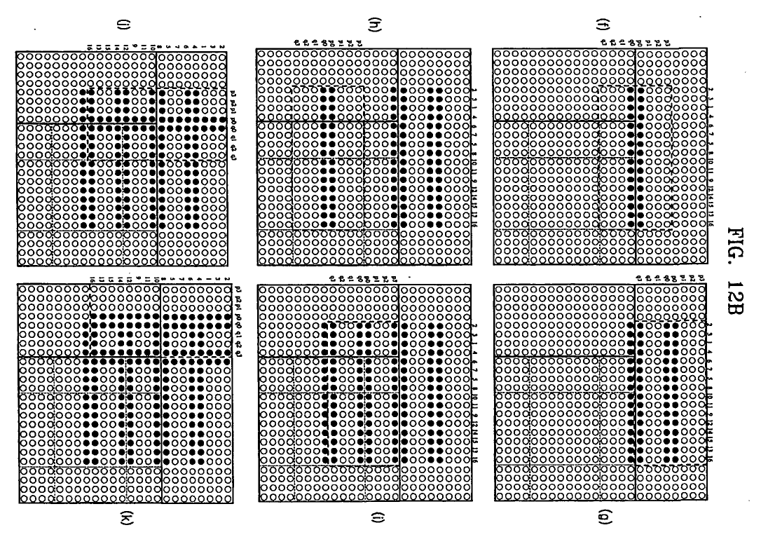

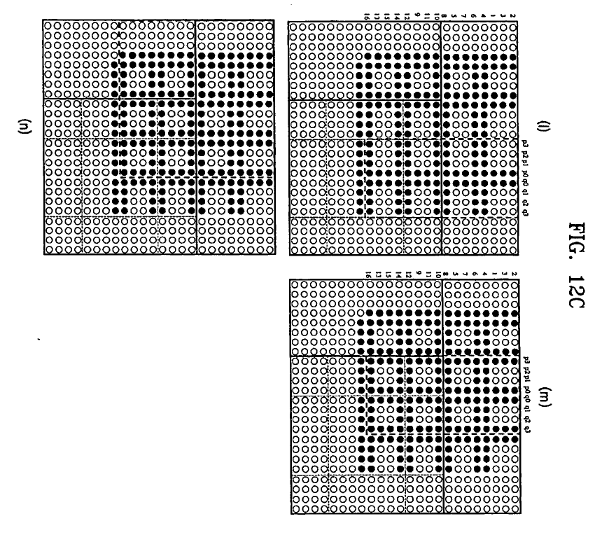

FIGS. 12A through 12C are diagrams illustrating the overlap smoothing and loop filtering of CASE 4 of FIG. 8, according to an exemplary embodiment of the present invention. Specifically, FIGS. 12A(b) through 12A(e) illustrate the overlap smoothing of CASE 4, FIGS. 12B(f) through 12B(i) illustrate the horizontal loop filtering of CASE 4, and FIG. 12B(j) through 12C(m) illustrate the vertical loop filtering of CASE 4. FIG. 12C(n) illustrates a result of overlap-smoothing and then loop-filtering CASE 4. The result of overlap-smoothing and then loop-filtering CASE 4 is recorded in the external frame memory.

The filtering apparatus according to the present invention perform an overlap smoothing operation and then a loop filtering operation in units of macroblocks, while a Conventional VC-1 filtering apparatus performs an overlap smoothing operation and then a loop filtering operation in units of frames. Accordingly, the filtering apparatus according to the present invention, unlike the Conventional VC-1 filtering apparatus, includes the row buffer 630 and the column buffer 640.

In other words, the filtering apparatus according to the present invention performs an overlap smoothing operation on each macroblock and then performs a horizontal loop filtering and then a vertical loop filtering operation on a corresponding macroblock. Pixels near a boundary between a current macroblock and a macroblock vertically or horizontally adjacent to the current macroblock are stored in the row buffer 630 or the column buffer 640 and then are excluded from the overlap smoothing and loop filtering of the current macroblock and are used when overlap-smoothing and loop-filtering the macroblock vertically or horizontally adjacent to the current macroblock.

Accordingly, the filtering apparatus according to the present invention is capable of performing a filtering operation in a causal manner, i.e., is capable of performing a filtering operation in units of macroblocks according to the passage of time. Therefore, the filtering apparatus according to the present invention can reduce a required memory bandwidth more considerably than a conventional filtering apparatus that performs a filtering operation in units of frames and thus can prevent frame delays.

However, the filtering method and apparatus according to the present invention that has been described above is difficult to control even though it is expected to more considerably reduce the required memory bandwidth than the prior art. Therefore, a filtering method and apparatus according to another exemplary embodiment of the present invention, which can reduce the required memory bandwidth less considerably but can be controlled more simply than the filtering method and apparatus according to the previous exemplary embodiment of the present invention, will now be described.

In the present exemplary embodiment, a horizontal filtering operation is separated from a vertical filtering operation. Specifically, supposing that there are a plurality of slices to be filtered, a first slice is horizontally overlap-smoothed and then horizontally loop-filtered in units of macroblocks. Thereafter, a second slice is horizontally overlap-smoothed and then horizontally loop-filtered in units of macroblocks. If the horizontal overlap smoothing and horizontal loop filtering of all of the slices to be filtered are complete, all of the slices are vertically overlap-smoothed and then vertically loop-filtered in an order in which they have been horizontally overlap-smoothed and then horizontally loop-filtered. Thereafter, after the vertical and horizontal overlap smoothing and vertical and horizontal loop filtering of all of the slices are complete, the vertical and horizontal overlap smoothing results and the vertical and horizontal loop filtering results are recorded in an external frame memory.

Even though a buffer unit, a row buffer, and a column buffer have been described above as if their sizes were restricted to those set forth herein. However, the sizes of the buffer unit, the row buffer, and the column buffer may be dynamically determined. For example, the sizes of the buffer unit and the row buffer in a horizontal direction may be extended to as large as one slice, in which case, a bandwidth required for loading data stored in the row buffer into a memory becomes unnecessary. In other words, as the size of each of the buffer unit, the row buffer, and the column buffer increases, a required memory bandwidth decreases. Thus, it is required to appropriately adjust the size of each of the buffer unit, the row buffer, and the column buffer and the required memory bandwidth in consideration between a trade-off therebetween.

As described above, the filtering method and apparatus according to the present invention can be used in an audio-video codec to perform a filtering operation in units of macroblocks in a causal manner. The filtering method and apparatus according to the present invention can be easily realized using a non-causal loop filter and buffers. The filtering method and apparatus according to the present invention can efficiently filter blocking artefacts without increasing a required memory bandwidth and causing frame delays.

The filtering method and apparatus according to the present invention are applicable not only to VC-1 codecs but also to codecs based on other standards.

In addition to the above described exemplary embodiments, exemplary embodiments of the present invention can also be implemented by executing computer readable code/instructions in/on a medium, e.g., a computer readable medium. The medium can correspond to any medium/media permitting the storing and/or transmission of the computer readable code.

The computer readable code can be recorded/transferred on a medium in a variety of ways, with examples of the medium including magnetic storage media (e.g., ROM, floppy disks, hard disks, etc.), optical recording media (e.g., CD-ROMs, or DVDs), and storage/transmission media such as carrier waves, as well as through the Internet, for example. The medium may also be a distributed network, so that the computer readable code is stored/transferred and executed in a distributed fashion.

Although a few exemplary embodiments of the present invention have been shown and described, it would be appreciated by those skilled in the art that changes may be made in these exemplary embodiments without departing from the principles and spirit of the invention, the scope of which is defined in the claims and their equivalents.

What is claimed is:

1. A filtering method used in an audio-video codec, comprising:
determining a predetermined macroblock as a filtering region;
expanding the filtering region to further include a portion of a macroblock adjacent to the predetermined macroblock near a boundary between the predetermined macroblock and the macroblock adjacent to the predetermined macroblock; and
performing a deblocking filtering operation on the expanded filtering region in units of macroblocks according to a passage of time.

2. The filtering method of claim 1, wherein performing the de-blocking filtering operation comprises:
performing a horizontal deblocking filtering operation on the expanded filtering region, and then performing a vertical deblocking filtering operation on the expanded filtering region; and
performing a horizontal deblocking filtering operation on a filtering region subsequent to the expanded filtering region, and then performing a vertical deblocking filtering operation on the subsequent filtering region.

3. The filtering method of claim 1, wherein the portion of the macroblock adjacent to the predetermined macroblock comprises a plurality of segments each comprised of at least 4 pixels.

4. The filtering method of claim 1, wherein the deblocking filtering operation comprises at least one of an overlap smoothing operation and a loop filtering operation.

5. The filtering method of claim 4, wherein the expanded filtering region is overlap-smoothed in units of macroblocks, if predetermined conditions are met, and then loop-filtered in units of the macroblocks.

6. The filtering method of claim 4, wherein the expanded filtering region is overlap-smoothed using at least two rows or columns of pixels at either side of a boundary between every pair of adjacent subblocks of a macroblock included in the expanded filtering region.

7. The filtering method of claim 4, wherein pixels near a boundary between two pairs of vertically adjacent 8×8 blocks of a macroblock included in the expanded filtering region are horizontally overlap-smoothed and then vertically overlap-smoothed.

8. The filtering method of claim 4, wherein the expanded filtering region is loop-filtered using at least four rows or columns of pixels at either side of the boundary between every pair of adjacent subblocks of a macroblock included in the expanded filtering region.

9. The filtering method of claim 4, wherein pixels near a boundary between two pairs of horizontally adjacent 8×8 blocks of a macroblock included in the expanded filtering region are horizontally loop-filtered, pixels near a boundary between every pair of horizontally adjacent 8×4 subblocks of the macroblock included in the expanded filtering region are horizontally loop-filtered, pixels near a boundary between two pairs of vertically adjacent 8×8 blocks of the macroblock included in the expanded filtering region are vertically loop-filtered, and pixels near a boundary between every pair of vertically adjacent 4×8 subblocks of the macroblock included in the expanded filtering region are vertically loop-filtered.

10. The filtering method of claim 1, wherein the audio-video codec follows VC-1 standard.

11. A filtering apparatus used in an audio-video codec, comprising:
a buffer unit, which stores a predetermined macroblock as a filtering region;
a row buffer, which stores a portion of a macroblock vertically adjacent to the predetermined macroblock near a boundary between the predetermined macroblock and the macroblock vertically adjacent to the predetermined macroblock;
a column buffer, which stores a portion of a macroblock horizontally adjacent to the predetermined macroblock near a boundary between the predetermined macroblock and the macroblock horizontally adjacent to the predetermined macroblock; and
a filtering unit, which performs a deblocking filtering operation on the filtering region stored in the buffer unit in units of macroblocks according to a passage of time.

12. The filtering apparatus of claim 11, wherein the filtering unit performs a horizontal deblocking-filtering operation and then a vertical deblocking-filtering operation on a filtering region and then performs the horizontal deblocking-filtering operation and the vertical deblocking-filtering operation on a subsequent filtering region.

13. The filtering apparatus of claim 11, wherein the portion of the macroblock vertically or horizontally adjacent to the predetermined macroblock stored in the row buffer or the column buffer comprises a plurality of segments each comprised of at least 4 pixels.

14. The filtering apparatus of claim 11, wherein the deblocking filtering operation comprises at least one of an overlap smoothing operation and a loop filtering operation.

15. The filtering apparatus of claim 14, wherein the overlap smoothing is performed in units of macroblocks, if predetermined conditions are met, and then the loop filtering operation are performed in units of the macroblocks.

16. The filtering apparatus of claim 14, wherein the overlap smoothing operation is performed using at least two rows or columns of pixels at either side of a boundary between every pair of adjacent subblocks of a macroblock included in the filtering region stored in the buffer unit.

17. The filtering apparatus of claim 14, wherein in the overlap smoothing operation, pixels near a boundary between two pairs of vertically adjacent 8×8 blocks of a macroblock included in the filtering region stored in the buffer unit are horizontally overlap-smoothed and then vertically overlap-smoothed.

18. The filtering apparatus of claim 14, wherein the loop filtering is performed using at least four rows or columns of pixels at either side of the boundary between every pair of adjacent subblocks of a macroblock included in the filtering region stored in the buffer unit.

19. The filtering apparatus of claim 14, wherein in the loop filtering operation, pixels near a boundary between two pairs of horizontally adjacent 8×8 blocks of a macroblock included in the filtering region stored in the buffer unit are horizontally loop-filtered, pixels near a boundary between every pair of horizontally adjacent 8×4 subblocks of the macroblock included in the filtering region stored in the buffer unit are horizontally loop-filtered, pixels near a boundary between two pairs of vertically adjacent 8×8 blocks of the macroblock included in the filtering region stored in the buffer unit are vertically loop-filtered, and pixels near a boundary between every pair of vertically adjacent 4×8 subblocks of the macroblock included in the filtering region stored in the buffer unit are vertically loop-filtered.

20. The filtering apparatus of claim 11, wherein the audio-video codec follows VC-1 standard.

21. At least one computer readable medium storing instructions that control at least one processor to perform a method comprising:
determining a predetermined macroblock as a filtering region;
expanding the filtering region to further include a portion of a macroblock adjacent to the predetermined macroblock near a boundary between the predetermined macroblock and the macroblock adjacent to the predetermined macroblock; and
performing a deblocking filtering operation on the expanded filtering region in units of macroblocks according to a passage of time.
